(19) United States
(12) Patent Application Publication
(10) Pub. No.: US 2024/0250547 A1
(43) Pub. Date: Jul. 25, 2024

(54) ADAPTIVE BATTERY BACKUP UNIT CHARGING SYSTEM AND METHOD

(71) Applicant: DELL PRODUCTS L.P., Round Rock, TX (US)

(72) Inventors: Craig Anthony Klein, Elgin, TX (US); Doug E. Messick, Austin, TX (US); Aaron M. Rhinehart, Georgetown, TX (US); Thomas R. Thibodeau, Whitinsville, MA (US)

(21) Appl. No.: 18/156,919

(22) Filed: Jan. 19, 2023

(51) Int. Cl. H02J 7/00; G06F 1/26

(52) U.S. Cl. CPC H02J 7/00712; G06F 1/263; H02J 7/0013; H02J 7/007192

(57) ABSTRACT

An information handling system may determine a battery charge rate to be applied to a battery backup unit, wherein the determining is based on a system power consumption and a system power limit. If the system power consumption is equivalent to an idle power limit then the battery charge rate applied to the battery backup unit is minimized, and if the system power consumption is between the idle power limit and the system power limit then the battery charge rate is maximized.

### FIELD OF THE DISCLOSURE

The present disclosure generally relates to information handling systems, and more particularly relates to an adaptive battery backup unit charging system and method.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may determine a battery charge rate to be applied to a battery backup unit, wherein the determining is based on a system power consumption and a system power limit. If the system power consumption is equivalent to an idle power limit then the battery charge rate applied to the battery backup unit is minimized, and if the system power consumption is between the idle power limit and the system power limit then the battery charge rate is maximized.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a system for adaptive battery backup unit charging, according to an embodiment of the present disclosure;

FIG. 3 is a flowchart illustrating a method for adaptive battery backup unit charging, according to an embodiment of the present disclosure;

FIG. 4 is a flowchart illustrating a method for adaptive battery backup unit charging, according to an embodiment of the present disclosure; and

FIG. 5 shows a graph illustrating an adaptive battery backup unit charging, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

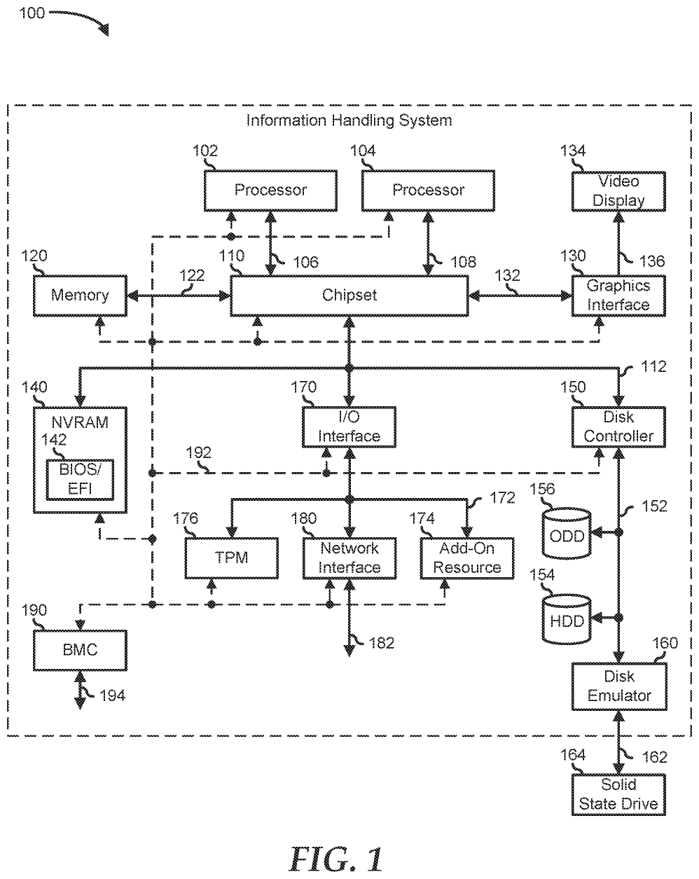

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

An information handling system may include one or more power supply units for providing electrical energy to components of the information handling system. Typically, a power supply unit is configured to operate from an input alternating current source of electrical energy, which the power supply unit converts to a direct current output. A battery backup unit may be capable of, immediately after removal of the alternating current source to the power supply unit, temporarily providing electrical energy as its output for a period of time using stored charge within battery cells to provide the output direct-current voltage.

Typically, the batteries in the battery backup unit are charged at the maximum allowable charge rate regardless of system need or the operational environment. This conventional charging technique can negatively impact compliance with idle power limits or requirements, reduce system performance when charging the battery while the information handling system is operating at a power limit, and increase the thermal stress on the system during a thermal event or excursion. Allocating the battery backup unit charging power at the maximum rate can also cause some configurations to fail the power budgeting check at the point of sale and reduce the options available to the customer. Accordingly, the present disclosure provides a system and method that varies the battery charge rate to account for the operating conditions of the information handling system instead of just a battery charging subsystem to address these and other concerns.

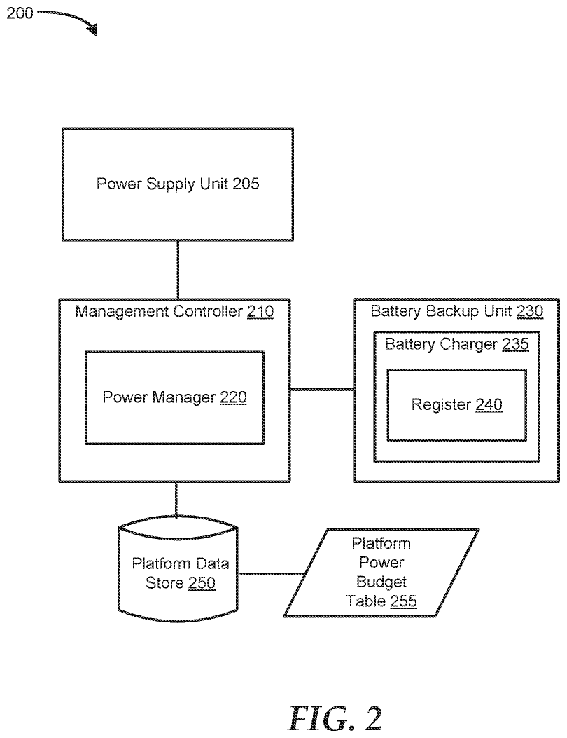

FIG. 2 illustrates a system 200 configured for adaptive charging of a battery backup unit. In particular, system 200 may be configured to charge one or more battery backup units while maximizing system performance, considering thermal controls, and providing the power needed for a persistent memory save or vaulting event. Thus, system 200 may mitigate negative behaviors and side effects associated with adding a battery backup unit and battery charger to a modern server. System 200 includes a power supply unit 205, a management controller 210, a battery backup unit 230, and a platform data store 250.

Power supply unit 205 may be configured to supply power to one or more components of an information handling system. Power supply unit 205 may be coupled to an alternating current power source and provide direct current to the components. One of skill in the art will recognize that power supply unit 205 may be replaced by any variety of power supply technologies while remaining within the scope of the present disclosure.

Battery backup unit 230 may be configured to provide power backup to the information handling system. Battery backup unit 230 may include a battery charger 235 with a register 240. Register 240 may be a programmable register, such as a charge requirement register, that allows management controller 210 to vary the battery charge rate of battery backup unit 230 during run-time operation. The battery charge rate, which may be applied to battery backup unit 230, is the rate at which battery charger 235 charges battery backup unit 230. Battery backup unit 230 may include more than one register. For example, battery backup unit 230 may include a maximum charge requirement and a minimum charge requirement. In one embodiment, the battery charge rate of battery backup unit 230 may be varied by adjusting the battery charge rate, also referred to as the battery charge current, via a closed-loop algorithm taking into account system utilization, system power consumption, power limits, thermal events, battery backup unit health, and battery backup unit charge status to optimize the battery backup unit charging profile.

Management controller 210, which is similar to BMC 190 of FIG. 1, may be configured to provide out-of-band and/or in-band management of the components of the information handling system. As such, management controller 210 may perform even if the information handling system is powered off or powered to a standby state. Management controller 210 may include a processor, memory, and an out-of-band network interface separate from and physically isolated from an in-band network interface of the information handling system and/or other embedded information handling resources. In certain embodiments, management controller 210 may include or may be an integral part of a BMC, embedded controller, service processor, or a remote access controller. In another embodiment, management controller 210 may include or may be an integral part of an enclosure controller. In some embodiments, management controller 210 may be configured to communicate with battery backup unit 230 to communicate control and/or telemetry data.

Management controller 210 may be coupled to battery backup unit 230 via an I²C bus or similar in a manner that allows management controller 210 to communicate to battery backup unit 230 and vice versa. Management controller 210 may also be coupled to platform data store 250 that may store platform associated with battery backup unit 230, power supply unit 205, etc. For example, platform data store 250 may store a platform power budget table 255 that includes the power requirements of system 200, charge/discharge requirements of battery backup unit 230, and/or any other information that would be apparent to one skill in the art in possession of the present disclosure. For example, management controller 210 may be configured to vary the battery charge rate to account for the operating conditions of system 200 instead of just looking at the battery charging subsystem.

Management controller 210 may include a power manager 220 in the management controller co-processor. The co-processor may be configured to monitor and/or collect telemetry data, such as the system power consumption, thermal measurements, etc. Power manager 220 may be configured to calculate or determine the battery charge rate for charging battery backup unit 230. Power manager 220 may be configured with a closed-loop control feature that calculates the battery charge rate based on one or more inputs, such as system utilization, system power, system power limit, thermal events, battery backup unit health, and battery backup unit charge status.

Management controller 210 may take an output of power manager 220, such as the battery charge rate, and programs register 240 with the output. This allows battery charger 235 to charge the in-system battery while gracefully controlling the battery charge rate. In one embodiment, power manager 220 may vary the battery charge rate to balance the following features: 1) preserve the low idle power, 2) maximize performance, 3) protect thermals, and 4) prioritize charging the battery backup unit when capacity is low. When the information handling system is operating at idle power, the battery charge rate may be reduced to preserve the low idle power. The battery charge rate may also be reduced to maximize the performance of system 200 when it is operating at the system power limit. The battery charge rate may also be reduced during a thermal event or excursion, such as when the CPU gets overheated or the ambient operational temperature of the information handling system is exceeded. In addition, the battery charge rate may be increased to prioritize charging battery backup unit 230 when its charge level is below a critical threshold.

Platform data store 250 is a storage system that supplies data storage services to components of system 200 such as management controller 210, wherein the components may be attached directly or through a network. Platform data store 250 may be a persistent data storage device, such as a solid-state disk, hard disk drive, magnetic tape library, optical disk drive, magneto-optical disk drive, compact disk drive, compact disk array, disk array controller, and/or any computer-readable medium operable to store data. In one embodiment, the platform data store may include a platform power budget table 255 which is responsible for storing platform-specific information. For example, platform power budget table 255 may store the minimum and maximum battery charge rates in watts or amperes for battery backup unit 230. Platform power budget table 255 may also include values for scaling factors and individual component power values, such as minimum component power, throttled component power, throttled component power, etc. for various components like CPUs, fans, drives, add-in cards, etc.

Those of ordinary skill in the art will appreciate that the configuration, hardware, and/or software components of system 200 depicted in FIG. 2 may vary. For example, the illustrative components within system 200 are not drawn to scale and are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. For example, connections between components may be omitted for descriptive clarity. In the discussion of the figures, reference may also be made to components illustrated in other figures for the continuity of the description.

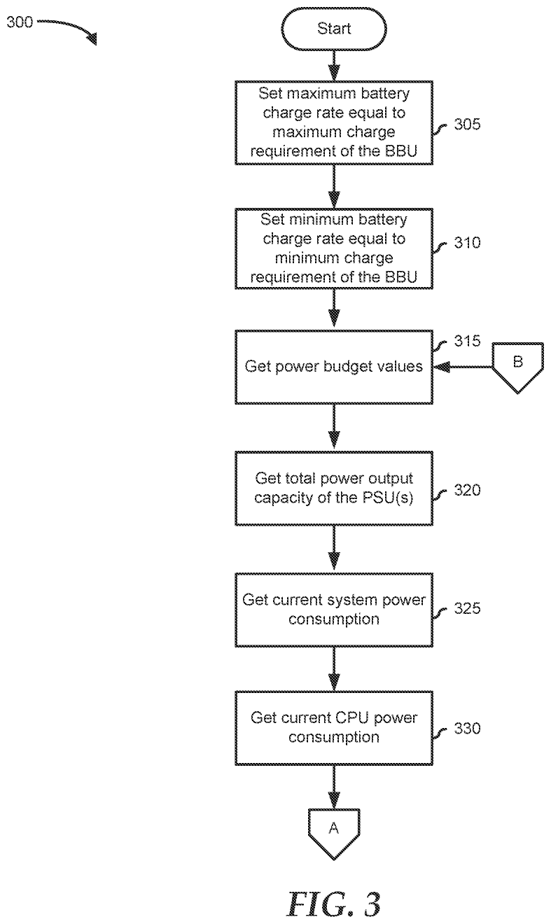

FIG. 3 shows a method 300 for adaptive battery backup unit charging. Method 300 may be a closed-loop algorithm for improving the typical battery backup charging mechanism. In particular, the present disclosure, in calculating the battery charge rate, accounts for system utilization, power limits, thermal events, BBU health, and BBU charge status to optimize the BBU charging profile. Method 300 may be performed by a management controller or a power manager in particular. However, while embodiments of the present disclosure are described in terms of system 200 of FIG. 2, it should be recognized that other systems may be utilized to perform the described method. One of skill in the art will appreciate that this flowchart explains a typical example, which can be extended to advanced systems in practice.

At block 305, a maximum battery charge rate may be set equal to a maximum charge requirement of the BBU. The value of the maximum charge requirement may be determined from a minimum charge requirement register at the BBU. The value of the maximum battery charge rate may be stored in a platform power budget table which is similar to platform power budget table 255 of FIG. 2. At block 310, a minimum battery charge rate may be set equal to a minimum charge requirement of the BBU. Similarly, the value of the minimum charge requirement may be determined from a minimum charge requirement register at the BUU. The value of the minimum battery charge rate may be stored in a platform power budget table.

At block 315, the power manager, which may be a closed-loop controller, may retrieve one or more values of attributes stored in the platform power budget table. For example, the power manager may retrieve the value for the attribute node lower boundary. At block 320, the power manager may retrieve the total output capacity of the power supply unit(s). If there is more than one power supply unit, then the total output capacity is the sum of the total output capacity of each of the power supply units.

At block 325, the power manager may determine the actual system power consumption. For example, the power manager may query a management controller or service processor to determine the actual system power consumption. At block 330, the power manager may retrieve the current CPU power consumption. Similarly, the power manager may query a management controller or service processor to determine the current CPU power consumption.

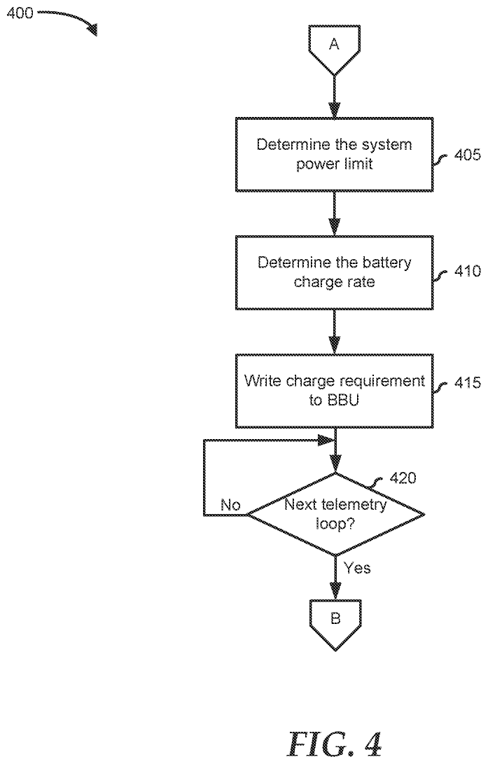

FIG. 4 shows a method 400 which is a continuation of method 300 of FIG. 3. Method 400 typically starts at block 405 which determines and sets the system power limit to be enforced. This is to limit the sustained power consumption of the information handling system. The system power limit may be set to an enabled system power limit during the boot or reboot process of the information handling system. If there are more than one system power limits that are enabled, then the power limit may determine the system power limit with the lowest value. However, if there are no enabled system power limits in place, then the power manager may determine the system power limit from one or more system values, such as from a hardware protection policy, system thermal policy, user policy, and power supply unit efficiency power.

The hardware protection policy refers to a power policy put in place that limits the system power consumption based on hardware power limits. The system thermal policy can be used to enforce power consumption limits when the system encounters elevated thermal conditions. The user policy refers to a power policy put in place by a customer that limits the system power consumption. This can be put in place for many reasons including overcurrent protection of the power distribution units in a rack or limiting power consumption during certain periods to avoid high energy costs. The power supply unit efficiency power is an attribute that refers to the power that the power supply unit is going to draw when the system is consuming a particular amount of power. Power supply units have an efficiency curve, and they are most efficient at certain levels of power draw. The attribute power supply unit efficiency power can be used to determine how much power the power supply unit is going to draw when the system is consuming a particular amount of power. An example equation for determining the system power limit is shown below:

$$System power limit = If ( SysPL 1 En \&\& SysPL 2 En , Minimum ( SysPL 1 , SysPL 2 ) ,$$

$$If ( SysPL 1 En , SysPL 1 , If ( SysPL 2 En , SysPL 2 , Minimum ( hardware protection policy , system thermal policy , user policy * power supply unit efficiency power ) ) ) )$$

In the above equation, SysPL1En (first system power limit enable) and SysPL2En (system power limit two enable) may be Boolean attributes that can either be set to true or false, wherein if SysPL1En is true, then SysPL1 (a first system power limit) is enabled, and wherein SysPL2En is true, then SysPL2 (a second system power limit) is enabled. Based on the equation if both SysPL1En and SysPL2En are set to true, then select the system power limit with the minimum value between SysPL1 and SysPL2. If only SysPL1En is true, then enforce SysPL1. Accordingly, if only SysPL2En is true then enforce SysPL2. Otherwise, if both SysPL1En and SysPL2En are set to false, then the system power limit may be set to the attribute with the minimum value among several attributes, such as hardware protection policy, system thermal policy, user policy, and power supply unit efficiency power.

At block 410, the power manager determines the battery charge rate which is how much power to allocate to the battery backup unit for charging. The battery charge rate may be determined based on the lowest value of several attributes. For example, the battery charge rate may be determined based on the following equation:

$$Battery charge rate = Minimum ( system power limit - ( idle power requirement - minimum battery charge rate ) , maximum ( system power limit * scaling factor - ( system power consumption - CPU power consumption + CPU dynamic power consumption ) , minimum battery charge rate ) , maximum battery charge rate )$$

The scaling factor may be applied to adjust the value of the system power limit. In one embodiment, the scaling factor may decrease the value of the system power limit. For example, the system power limit may be multiplied by 0.95. At block 415, the power manager may update the charge requirement register of the battery backup unit with the value of the battery charge rate determined at block 410. At decision block 420, the method tracks whether it is time for the next telemetry loop. The telemetry data associated with determining the battery charge rate in real time may be collected and/or received periodically, such as every minute, every five minutes, every half hour, hourly, etc. If it is time for the next telemetry loop, then the “YES” branch is taken, and the method proceeds to block 315 of FIG. 3. If it is not time for the next telemetry loop, then the “NO” branch is taken, and the method loops back to decision block 420.

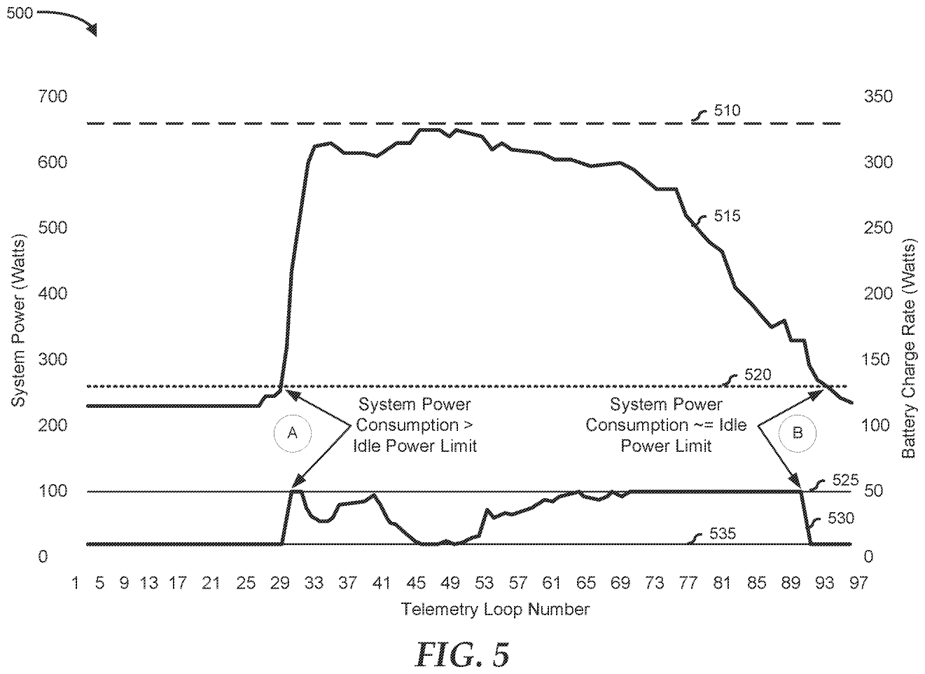

FIG. 5 shows a graph 500 that illustrates a relationship between the battery charge rate and system power consumption. In particular, graph 500 shows varying the battery charge rate according to idle power requirements while maximizing the performance of the information handling system. The power manager may set the battery charger to the minimum charge rate when the system utilization, also referred to as system power consumption, is at a significantly low state such as when the information handling system is on idle power. This is performed to prevent inflating the idle power. Meanwhile, the battery charge rate may be maximized when the information handling system is operating above the idle power and below the system power limit. Graph 500 includes system power consumption in watts along the left vertical axis, a battery charge rate in watts along the right vertical axis, and a telemetry loop number along the horizontal axis. In this example, the system power limit, as depicted by a line 510 is at approximately 650 watts while the maximum battery charge rate depicted by a line 525 is at fifty watts and the minimum battery charge rate depicted by a line 535 is at five watts. The idle power is depicted in a line 520. Collection and/or receipt of telemetry data along with calculating the battery charge rate may be performed at each telemetry loop.

In this example, a curve 530 shows the battery charge rate while a curve 515 shows the system power consumption. The values of the battery charge rate and the system power are sampled or taken at a particular time for a period for each telemetry loop. At each calculation, the battery charge rate may fluctuate from the minimum battery charge rate to the maximum charge rate. While the system power consumption may fluctuate from approximately the idle power to approximately the system power limit.

Idle power is the power consumed by the system when the CPUs are not executing instructions or fetching data. The node lower boundary is a CPU budgeting attribute that signifies a maximum throttled CPU power state. The power manager may vary the battery charge rate based at least in part on the idle power and the system power. If the system power is less than or equal to the idle power, then the power manager may set the battery charge rate to the minimum battery charge rate. If the system power is greater than the idle power and node lower boundary and the PSUs are not providing maximum power to the system, then the power manager may set the battery charge rate to the maximum charge rate. This prevents the idle power from increasing when charging the battery backup unit. If the CPU power is being throttled to the node lower boundary, then the power manager may set the battery charge rate to the minimum battery charge rate. The management controller may determine the node lower boundary based on the current system configuration of the information handling system.

Various mechanisms may be used to determine whether the information handling system is operating on a lower power state. For example, the low power state may be determined by using an idle detection apparatus, monitoring the CPU power performance states (P-states) and processor idle sleep states (C-states), comparing power consumption to power budgeting and inventory data that may have been modified by a scaling factor, and comparing power consumption to a pre-defined system power consumption threshold. The scaling factor is a control that can be applied to the total actual system power consumption to prevent the battery backup unit from utilizing the power that could be utilized by fast performance spikes when the system is power constrained.

As shown, the battery charge rate may be at a minimum battery charge rate when the system power is at a low power state or idle power. The battery charge rate may increase as the actual system power consumption, also referred to herein simply as system power consumption, increases. The battery charge rate may also decrease as the actual system power consumption increases as depicted at point A, wherein the actual system power consumption is greater than idle power requirement.

The power manager may modify a charge requirement attribute to maximize system performance at run time. Whenever the actual system power consumption approaches the system power limit, the power manager can choose to prioritize system performance over the battery charge rate by reducing the charge requirement to the minimum battery charge rate and allocating the rest of the system power for the other components of the information handling system as depicted in point B. Accordingly, the system power limit can be defined by the following equation:

$$System power limit = System power + Minimum battery charge rate$$

The maximum battery charge rate may be the maximum power that the battery backup unit can draw when charging. The minimum battery charge rate may be the minimum power that the battery charge rate can draw when charging. These values are defined in the platform power budget table. When the power manager determines that there is additional system power headroom available, the charge requirement can be increased up to the maximum battery charge rate. A buffer, also referred to as a scaling factor may be defined in the platform power budget table to prevent the programmed charge requirement from driving system throttling by increasing or decreasing the system power consumption. Such as when:

$$System Power Limit > System Power * scaling factor + minimum battery charge rate then maximum battery charge rate >= battery backup unit charge requirement <= system power limit - system power consumption * scaling factor$$

Based on the above equation, if there is power headroom available, the power manager can increase the amount of power allocated to the battery backup unit above the minimum battery charge rate up to the maximum battery charge rate based on the value of the battery backup unit charge requirement register as long as it doesn't rob power from the opportunistic performance allocation. For example, if the system power limit is equal to 1500 watts and the scaling factor is 1.2 which is 20% above the current consumption, wherein the minimum battery charge rate is one watt and the maximum battery charge rate is twenty watts, then as long as the system power consumption is less than 1,229 watts, the battery charge requirement could be as high as twenty-five watts. While the information handling system is consuming between 1229 watts and 1249 watts, the battery charge requirement can decrease linearly from twenty-five watts to one watt. However, while the information handling system is consuming 1249 watts or more, the battery charge rate may be limited to one watt. The calculations above would change if a different scaling factor and system power limit is used. A change in the system power limit may shift the window, while a change in the scaling factor may change the size of the window and the slope of the linear region.

The battery charge rate is dynamically calculated by the power manager to use the available power headroom when operating near a system power limit without driving the total power consumption over the system power limit. The attribute charge requirement may be modified by the power manager when there is a thermal event or excursion from standard thermal conditions to minimize the heat generated when charging the battery backup unit. For example, the battery charge rate may be reduced when the CPU is overheating. Varying the battery charge rate may also be based on power control policies that are enacted by the thermal subsystem when there is a system thermal event or excursion. In another example, the power manager may reduce the charge requirement to as low as the battery minimum charge rate.

The battery charge rate can be adjusted based on the amount of energy stored in the BBU during the charging process. It is generally desired that the BBU reaches a charge level that can support a single persistent memory save or vaulting event as soon as possible to allow the system to function in the non-volatile storage mode, but once that threshold is reached, further charging can happen at a slower rate. The minimum energy vaulting threshold (MEVT) may be the minimum charge level to support the single vaulting event and may be calculated based on the system inventory that includes the CPU, memory, and storage configurations. The management controller monitors the charging process and may alter the battery charge rate(s) based on the MEVT and as defined by the user.

In another embodiment, with an information handling system where there are multiple battery backup units, each with different charge levels, the charge requirement can be updated uniformly for all of the battery backup units or each battery backup unit by the power manager based on information gathered from the battery backup units, such as current charge level, cell temperature, or other relevant battery health information. This allows the system to optimize battery charging time and capacity. Each battery backup unit can also have its charge requirement set to different levels. This is particularly useful in the case that a single battery or a battery backup unit is replaced in a system and needs to charge quickly to match the charge of the other system batteries or battery backup units.

In yet another embodiment, with information handling systems that feature redundant power supply units, the charge requirement can be set to optimize the battery charging time and capacity when there are more power supplies available than are required to power the system. The battery charging rate of the battery backup unit can be reduced or disabled when a power supply unit goes offline to provide more power to the system. When the power supply unit returns to service and the amount of available power is more than the power required by the information handling system for the current operation, the charge requirement can be set back to its previous value before one of the power supply units goes offline. This optimizes the battery charging time and capacity.

Although FIG. 3, and FIG. 4 show example blocks of method 300 and method 400 in some implementations, method 300 and method 400 may include additional blocks, fewer blocks, different blocks, or differently arranged blocks than those depicted in FIG. 3 and FIG. 4. Those skilled in the art will understand that the principles presented herein may be implemented in any suitably arranged processing system. Additionally, or alternatively, two or more of the blocks of method 300 and method 400 may be performed in parallel. For example, blocks 305 and 310 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
determining, by a processor, a battery charge rate to be applied to a battery backup unit, wherein the determining is based on a system power consumption and a system power limit;
in response to determining that the system power consumption is equivalent to an idle power limit, minimizing the battery charge rate applied to the battery backup unit; and
in response to determining that the system power consumption is between the idle power limit and the system power limit, maximizing the battery charge rate applied to the backup battery unit.

2. The method of claim 1, further comprising modifying the battery charge rate in response to a thermal system event.

3. The method of claim 1, further comprising modifying the battery charge rate in response to the battery backup unit reaching a minimum energy vaulting threshold event threshold.

4. The method of claim 1, further comprising in response to determining that a power supply unit of a plurality of power supply units goes offline, disabling charging the battery backup unit while the power supply unit is offline.

5. The method of claim 1, wherein the battery charge rate is applied to a plurality of battery backup units.

6. The method of claim 1, further comprising updating a charge requirement register of the battery backup unit with the battery charge rate.

7. The method of claim 1, wherein a scaling factor is used as a buffer in calculating a maximum battery charge rate.

8. An information handling system, comprising:
a processor; and
a memory storing instructions that when executed cause the processor to perform operations including:
determining a battery charge rate to be applied to a battery backup unit, wherein the determining is based on a system power consumption and a system power limit;
in response to determining that the system power consumption is equivalent to an idle power limit, minimizing the battery charge rate applied to the battery backup unit; and
in response to determining that the system power consumption is between the idle power limit and the system power limit, maximizing the battery charge rate applied to the backup battery unit.

9. The information handling system of claim 8, wherein the operations include modifying the battery charge rate in response to a thermal system event.

10. The information handling system of claim 8, wherein the operations include modifying the battery charge rate in response to the battery backup unit reaching a minimum energy vaulting threshold event threshold.

11. The information handling system of claim 8, wherein the operations includes in response to determining that a power supply unit of a plurality of power supply unit goes offline, disabling charging the battery backup unit while the power supply unit is offline.

12. The information handling system of claim 8, wherein the battery charge rate is applied to a plurality of battery backup units.

13. The information handling system of claim 8, wherein a scaling factor is used as a buffer in calculating a maximum battery charge rate.

14. A non-transitory computer-readable medium to store instructions that are executable to perform operations comprising:
determining a battery charge rate to be applied to a battery backup unit, wherein the determining is based on a system power consumption and a system power limit;
if the system power consumption is equivalent to an idle power limit, then minimizing the battery charge rate applied to the battery backup unit; and
if the system power consumption is between the idle power limit and the system power limit, then maximizing the battery charge rate applied to the backup battery unit.

15. The non-transitory computer-readable medium of claim 14, wherein the operations include modifying the battery charge rate in response to a thermal system event.

16. The non-transitory computer-readable medium of claim 14, wherein the operations include modifying the battery charge rate in response to the battery backup unit reaching a minimum energy vaulting threshold event threshold.

17. The non-transitory computer-readable medium of claim 14, wherein the operations include in response to determining that a power supply unit of a plurality of power supply units goes offline, disabling charging the battery backup unit while the power supply unit is offline.

18. The non-transitory computer-readable medium of claim 14, wherein the battery charge rate is applied to a plurality of battery backup units.

19. The non-transitory computer-readable medium of claim 14, wherein the operations include updating a charge requirement register of the battery backup unit with the battery charge rate.

20. The non-transitory computer-readable medium of claim 14, wherein a scaling factor is used as a buffer in calculating a maximum battery charge rate.
